(19) United States
(12) Patent Application Publication
(10) Pub. No.: US 2016/0207441 A1
(43) Pub. Date: Jul. 21, 2016

(54) STOWABLE RACK FOR CARGO LOAD SECUREMENT STRUCTURES

(71) Applicant: SHAMEEN KHAN, BRAMPTON (CA)

(72) Inventor: SHAMEEN KHAN, BRAMPTON (CA)

(21) Appl. No.: 14/599,473

(22) Filed: Jan. 17, 2015

(51) Int. Cl. B60P 7/15

(52) U.S. Cl. CPC B60P 7/15

(57) ABSTRACT

A rack assembly has a brace bar with first and second opposing end portions. The first end portion terminates in a crossbar comprised of a first arm opposite a second arm. The first arm is fixed between the brace bar and a shaft. A sleeve receives the shaft, with at least one of the shaft and the sleeve pivoting relative to the other about a pivot axis. The brace bar is rotatable about the pivot axis with the crossbar fixed thereto. A slot connector includes a body fixed to the sleeve, and a catch pivotally coupled to the body. The body defines a first notch opposite a second notch, both of which are opposite the sleeve. The connector is structured to selectively engage/release a slot, and the notches are structured to receive opposing edges about the slot when the connector engages the slot.

### FIELD

The present application relates generally to storage racks; and more particularly, but not exclusively relates to: techniques, systems, methods, apparatus, and devices directed to a rack for cargo load securement structures used in the cargo area of a vehicle or shipment container.

### BACKGROUND

Cargo vans, delivery trucks, tractor trailers, and the like are a mainstay of over-the-road, non-bulk freight transportation going to multiple destinations. Along a given route, if the type or amount of freight being delivered differs with destination, efforts are often made to separately crate, palletize, pack, secure, support, and/or otherwise load in accordance with a first-in, last-out delivery schedule. Such efforts decrease the chance of cargo damage or misdelivery. Loading, support, securement, and separation is frequently maintained by using loading bars and/or shoring beams. These devices are also employed to prevent movement of freight when the vehicle is only partially loaded or otherwise would benefit from load/cargo securement techniques to avoid overloading one part of the vehicle to the detriment of another, create a load imbalance likely to shift during nominal operation posing a safety hazard, and/or to provide a load-bearing platform to separate a tall stack of goods that might otherwise cause damage to the lower part of the stack because of the weight bearing from the top part of the stack. Perhaps to a lesser extent, railway cars, ships, aircraft freight, and/or shipping containers may be managed in a comparable way—especially when carrying broken down cargo or other non-bulk loading (sometimes called “break bulk cargo”).

Unfortunate consequences can result when loading bars and/or shoring beams are haphazardly moved from time-to-time along multi-stop delivery routes as different portions of the cargo are delivered—especially is unused loading bars/shoring beams are loose in the cargo interior or only loosely secured. Indeed, it often becomes necessary to properly restrain loading bars and/or shoring beams as deliveries progress. However, management of loading bars and shoring beams can be quite daunting and/or time consuming. For instance, such restraining apparatus may itself be loose when not in use, be difficult to adequately store without taking-up much needed space, and/or impose other constraints. Indeed, existing schemes often can be cumbersome to use, and may make it difficult to readily and consistently obtain a satisfactory result in certain instances. Accordingly, there remains an ongoing demand for further contributions in these technical arenas.

### SUMMARY

By way of transition from the background to the summary/detailed description of the inventions of the present application, a few specific definitions are set forth below and supplemented by example or further explanation, as applicable:
1. “Cargo load securement structure” broadly includes any of: a shoring beam, a shoring bar, a shore bar, a securing bar, a securing beam, a securement beam, a securement bar, a shoring beam hoop, dunnage, a decking beam, a decking bar, a load bar, a load beam, a support beam, a support bar, I-beam, wood beam, board, cargo/load securement/securing support device/structure, cargo/load securement/securing device/structure, cargo/load securement/securing support, cargo/load support beam/bar, or the like—to name just a few nonlimiting examples.
2. “Track” and “slot track” each broadly include any form of: spaced-apart slots for connection/mounting/securing/attachment/support of one or more cargo load securement structures (defined above); E-track and corresponding slot arrangements (often horizontally or vertically oriented), a flush alignment of spaced-apart slots along a wall or other surface; or track/rail/wall/surface defining one or more slots/grooves/apertures/holes/openings/passages/channels/slits/gaps/recesses for the connection/mounting/securing/attachment/support of one or more cargo load securement structures (defined above); or the like—to name just a few nonlimiting examples.
   The above quoted language and definitions listed above apply to any reference to the corresponding terminology herein unless explicitly set forth otherwise. All acronyms, abbreviations, and terms parenthetically defined herein apply to the same extent.

Among the embodiments of the present application are unique techniques to manage load securement supports for a cargo-carrying vehicle or container. Other embodiments include unique devices, apparatus, methods, and systems to arrange and store cargo/load securement supports, and the like. Such embodiments may utilize common track/slot connectivity and may not necessarily require disassembly into separate, loose parts for storage.

Another embodiment is directed to a method, comprising: connecting a first rack assembly along an interior wall of a cargo area of a vehicle with a first connector, the first rack assembly including a guide bar fixed to a crossbar that is coupled to the first connector. The first rack assembly is positioned to project an arm of the crossbar away from the interior wall and direct the guide bar upwardly from the crossbar. Also included is selecting a first cargo securement support defining a passage therethrough and placing the guide bar through the passage to rest the first cargo securement support on the crossbar.

Among various optional refinements of this embodiment include, but are not limited to: equipping the cargo area with a second rack assembly including a further guide bar fixed to a further crossbar and a second connector coupled to one end of the further crossbar; coupling the first connector to a first slot and the second connector to a second slot along the interior wall, the first slot belonging to a first slot track and the second slot belonging to a second slot track, the first slot track and the second slot track being approximately parallel to one another; configuring the second rack assembly to project the further crossbar from the interior wall and upwardly direct the further guide bar therefrom; and putting the further guide bar through a further passage defined by the first cargo securement support at an end opposite the passage to rest the first cargo securement support on the further crossbar. A further optional refinement includes without limitation: removing the cargo securement support from the first rack assembly and the second rack assembly and pivoting the guide bar and crossbar and the further guide bar and the further crossbar to be closer to the interior wall. Alternatively or additionally, further optional refinements include, but are not limited to: selecting a second cargo securement support defining a first protruding slot opposite a second protruding slot; projecting the guide bar through the first protruding slot and the further guide bar through the second protruding slot to stack the second cargo securement support on the first cargo securement support; selecting a third cargo securement support defining a first protruding aperture opposite a second protruding aperture; and placing the guide bar through the first protruding aperture and the further guide bar through the second protruding aperture to stack the third cargo securement support on the second cargo securement support.

In other alternatives or additions to such embodiments, various optional forms/refinements may include, but are not limited to: the positioning of the first rack assembly by pivoting the guide bar and the crossbar relative to the first connector and the interior wall while the first connector engages a first slot defined along the interior wall; equipping the first rack assembly with a shaft and a sleeve; receiving the shaft in the sleeve that is fixed to the first connector; rotating the shaft in the sleeve during the pivoting of the guide bar and the crossbar with a corresponding rotational axis longitudinally extending through the shaft and the sleeve; implementing the first connector with a pivotal catch having a pivot axis generally perpendicular to the rotational axis; activating the catch to at least one of engage the first connector to the first slot and release the first connector from the first slot; providing a second rack assembly with a further guide bar fixed to a further crossbar that includes a first arm opposite a second arm, where the first arm is fixed to a shaft opposite the further guide bar and the second arm projects away from the interior wall with the guide bar extending upwardly therefrom; including the second rack assembly with a further sleeve receiving the further shaft therein and a second connector fixed to the sleeve; equipping the second connector with a first foot opposite a second foot each being positioned under opposing edges of a second slot when engaged thereto; putting the further guide bar through a further passage defined by the cargo securement support to rest on the further crossbar; supplying the first slot with a first edge opposing a second edge; providing the first connector with a first notch opposing a second notch each receiving those edges, respectively; and the first foot and the second foot being positioned opposite the further sleeve; lifting the first cargo securement support from the first rack assembly to remove the guide bar from inside the passage and the second rack assembly to remove the further guide bar from inside the further passage; and/or swinging the first rack assembly and the second rack assembly to move the guide bar, the crossbar, the further guide bar, and the further crossbar closer to the interior wall after the lifting of the first cargo securement support.

Yet another embodiment is directed to a method, comprising: installing a load securement support rack along an interior wall of a cargo carrying area of a vehicle, the load securement support rack including a first rack assembly and a second rack assembly; with the first rack assembly, including a first guide post fixed to a first crossbar, a first shaft, a first sleeve, and a first slot connector, the first crossbar including a first inner arm fixed between the first guide post and the first shaft, the first outer arm being fixed to the first guide post opposite the first inner guide post, the first sleeve receiving the first shaft, the first slot connector being fixed to the first sleeve; with the second rack assembly, including a second guide post fixed to a second crossbar, a second shaft, a second sleeve, and a second slot connector, the second crossbar including a second inner arm fixed between the second guide post and the second shaft, the second outer arm being fixed to the second guide post opposite the second inner guide post, the second sleeve receiving the second shaft, the second slot connector being fixed to the second sleeve; coupling the first slot connector to a first slot of a first slot track and the second slot connector to a second slot of a second slot track, the first slot track being approximately parallel to the second slot track; during the coupling of the first slot connector to the first slot and the second slot connector to the second slot: pivoting the first guide post and the first crossbar toward the interior wall and the second guide post and the second crossbar toward the interior wall; rotating the first crossbar to project the first outer arm away from the interior wall, the second crossbar to project the second outer arm away from the interior wall, and the first guide post and the second guide post upward; and repetitively mounting different cargo securement structures one on the next by guiding the first guide post through one different passageway and the second guidepost through another different passageway defined by opposing ends of the different cargo securement structures, until the mounting of the different cargo securement structures forms a stack of at least five resting on one another and the first crossbar and the second crossbar; and removing one of the different cargo securement structures from on top of the stack by lifting off of the first guide post and the second guide post; and after the removing of the one of the different cargo securement structures from the stack, positioning the one of the different cargo securement structures across a cargo interior of a vehicle between different interior wall portions.

A further embodiment includes: a first rack assembly, the first rack assembly including: an elongate brace bar with a first end portion opposite a second end portion; a crossbar connected to the first end portion of the elongate bar that has a first arm opposite a second arm; a sleeve defining a passage, the passage receiving a stem fixed to the first arm—at least one of the stem and the sleeve pivoting about a rotational axis relative to another of the stem and the sleeve, such that the elongate bar is rotatable about the rotational axis with the crossbar. The rotational axis extend through the passage and the stem. Also included is an E-track connector including a body fixedly connected to the sleeve, a body with a catch pivotally coupled thereto, with the body defining a first notch opposite a second notch that are both opposite the sleeve. The E-track connector is structured to position the catch to provide at least one of E-track slot engagement and E-track slot release, the first notch and the second notch being sized and structured to selectively receive opposing edges of the slot when the E-track connector engages the same.

A further embodiment comprises a system, including: a first rack assembly to selectively couple to a slot of a first slot track along an interior wall of a cargo hauling area including: a first shaft; a first elongate mounting bar; a first crossbar including a first inner arm opposite a first outer arm, the first inner arm being fixed between the first elongate mounting bar and the first shaft, the first outer arm connected to the first elongate mounting bar opposite the first inner arm; a first sleeve receiving the first shaft, at least one of the first shaft and the first sleeve pivoting about a first rotational axis relative to another of the first shaft and the first sleeve, the first elongate mounting bar being pivotal about the first rotational axis with the first crossbar; and a first slot connector including a first body connected to the first sleeve, a first catch pivotally coupled to the first body to pivot about a first pivot axis, the first pivot axis crossing the first rotational axis in a first approximately perpendicular relationship being spaced apart from one another by at least a portion of the first body, the first catch being selectively actuated to at least one of engage the first slot connector with the slot of the first slot track and release the first slot connector from the slot of the first slot track.

In an optional refinement of this embodiment, the system includes: a load securement support rack including the first rack assembly and a second rack assembly, the second rack assembly to selectively couple to a slot of a second slot track along the interior wall, the first slot track being approximately parallel to the second slot track, the second rack assembly including: a second shaft; a second elongate mounting bar; a second crossbar including a second inner arm opposite a second outer arm, the second inner arm being fixed between the second elongate mounting bar and the second shaft, the second outer arm connected to the second elongate mounting bar opposite the second inner arm; a second sleeve receiving the second shaft, at least one of the second shaft and the second sleeve pivoting about a second rotational axis relative to another of the second shaft and the second sleeve, the second elongate mounting bar being pivotal about the second rotational axis with the second crossbar; and a second slot connector including a second body connected to the second sleeve, a second catch pivotally coupled to the second body to pivot about a second pivot axis, the second pivot axis crossing the second rotational axis in a second approximately perpendicular relationship being spaced apart from one another by at least a portion of the second body, the second catch being selectively actuated to at least one of engage the second slot connector with the slot of the second slot track and release the second slot connector from the slot of the second slot track. Still another embodiment includes a first rack assembly with means for installing along an interior wall of a cargo area of a vehicle, the first rack assembly also includes means for guiding and means for supporting stacked cargo securement structures. The assembly further has means for pivotally coupling to the installing means. The guiding and supporting means includes means for projecting the same away from the interior wall. The stacked cargo securement structures includes means for defining a passage therethrough. Further included are means for placing the guiding means through the passage to rest the stacked cargo securement structures on the supporting means. In one embodiment of a system of the present application, a rack for load securing structures includes a first rack assembly pivotally connected to a first slot track and a second rack assembly pivotally connected to a second slot track. The first rack assembly includes: an elongate first brace bar, a first shaft, a first crossbar with a first inner arm fixed between the first brace bar and the first shaft, and a first outer arm opposite the first inner arm and extending away from the first brace bar. A first sleeve receiving the first shaft therein and a first slot connector with a first connector body fixed to the first sleeve. The first connector includes a first pivotal catch structured to be pivoted about a first pivotal axis to at least one of selectively engage the first connector with a first slot or release the first connector from the first slot. Opposite the sleeve, the first connector includes at least one of: (a) a first foot opposite a second foot operable to slide beneath opposing edges about the first slot when the first connector is engaged therewith and (b) a first notch opposite a second notch operable to receive opposing edges about the first slot when the first connector is engaged therewith. The first brace bar and the first crossbar are operable to rotate about a first rotational axis approximately perpendicular to the first pivotal axis. The second rack assembly includes: an elongate second brace bar, a second shaft, a second crossbar with a second inner arm fixed between the second brace bar and the second shaft, and a second outer arm opposite the second inner arm and extending away from the second brace bar. A second sleeve receiving the second shaft therein and a second slot connector with a second connector body fixed to the second sleeve. The second connector includes a second pivotal catch structured to be pivoted about a second pivotal axis to at least one of selectively engage the second connector with a second slot or release the second connector from the second slot. Opposite the sleeve, the second connector includes at least one of: (a) two opposing feet each operable to slide beneath opposing edges about the second slot when the second connector is engaged therewith and (b) two opposing notches to receive opposing edges about the second slot when the second connector is engaged therewith. The second brace bar and the second crossbar are operable to rotate about a second rotational axis approximately perpendicular to the second pivotal axis. In one form, the first slot track and the second track are approximately parallel to each other and to the first and second rotational axes. Alternatively or additionally, the first and second slot tracks may each be a type of E-track, a vehicle is included with an interior cargo space carrying the rack, the first and second slot tracks each extend along an interior wall of a vehicle cargo space, means for carrying multiple cargo or load securement supports is provided by the rack, the first and/or second catch is spring-loaded, and/or means for providing cargo or load securement support structures or devices stacked on the rack.

Other additions, advantages, alterations, apparatus, applications, aspects, benefits, changes, components, compositions, constituents, devices, embodiments (described or undescribed), equivalents, features, forms, implementations, materials, methods, modifications, objects, operations, options, processes, refinements, structures, substitutions, subtractions, systems, techniques, and variations shall become apparent from the written description and any drawing(s) provided herewith.

### BRIEF DESCRIPTION OF THE DRAWING(S)

Throughout the following figures, like reference numerals and characters earlier introduced refer to like features previously described therewith:

FIG. 1 is a partially diagrammatic, perspective, cut away view of a vehicle showing an interior cargo area.

FIG. 2 is a partially diagrammatic elevational view of a rack assembly for load securement supports that may be included in the interior cargo area of FIG. 1.

FIG. 3 is a perspective, partially exploded assembly view of a connector included in the rack assembly of FIG. 2.

FIG. 4 is a perspective view of the assembled connector of FIG. 3 for use with the rack assembly of FIG. 2.

FIG. 5 is a partial sectional, diagrammatic view of the connector of FIG. 4 during installation in a flush track slot.

FIG. 6 is a partial sectional, diagrammatic view of the connector of FIG. 4 fully installed in the flush track slot.

FIG. 7 is a partial, diagrammatic cut away view of a cargo area with a storage rack comprised of two rack assemblies coupled to different slots of an interior wall and rotated about respective pivotal axes for storage.

FIG. 8 is a partial, diagrammatic cut away view of the cargo area of FIG. 7 with the rack arranged so the rack assemblies are rotated to project from the interior wall to prepare to receive load securement supports. The view line 9-9 in FIG. 8 corresponds to the FIG. 9 view.

FIG. 9 is a partially diagrammatic, side elevational view of a rack assembly corresponding to the view line 9-9 shown in FIG. 8.

FIG. 10 is a partially diagrammatic, top plan view of the rack of FIG. 9 showing a cargo load securement structure corresponding to the view line 10-10 shown in FIG. 11. The view line 11-11 in FIG. 10 corresponds to the view of FIG. 11.

FIG. 11 is a partially diagrammatic, side elevational view of the rack of FIG. 10 illustrating several stacked cargo load securement structures corresponding to the view line of 11-11 shown in FIG. 10. The view line 10-10 in FIG. 11 corresponds to the view of FIG. 10.

### DETAILED DESCRIPTION OF REPRESENTATIVE EMBODIMENTS

In the following description, numerous specific details are given to provide a thorough understanding of various representative embodiments of the present application. One skilled in the relevant art shall recognize, however, that any inventions of the present application can be practiced without one or more of the specific details, or with other additions, advantages, alterations, apparatus, applications, aspects, benefits, changes, components, compositions, constituents, devices, embodiments (described or undescribed), equivalents, features, forms, implementations, materials, methods, modifications, objects, operations, options, processes, refinements, structures, substitutions, subtractions, systems, techniques, variations, or the like. In other instances, well-known aspects are not shown or described in detail to avoid obscuring innovative characteristics. Thus, for the purposes of promoting an understanding of the principles of any inventions set forth herein, reference shall now be made to representative embodiments, any drawing(s), and specific language shall be used to describe the same. It shall nevertheless be understood that no limitation of the scope of any inventions or embodiments are intended thereby. From the written description and any drawing(s) provided herein, it shall also become apparent that other additions, advantages, alterations, apparatus, applications, aspects, benefits, changes, components, compositions, constituents, devices, embodiments (described or undescribed), equivalents, features, forms, implementations, materials, methods, modifications, objects, operations, options, processes, refinements, structures, substitutions, subtractions, systems, techniques, and variations, may also be realized without departing from the scope of any inventions set forth herein or in any of the claims listed hereafter.

One nonlimiting embodiment of the present application is directed to a unique technique to manage, handle, arrange, and store cargo securement supports. In one form, a storage rack includes two swinging support rack assemblies. Each rack assembly includes a slot connector with a catch to provide for at least one of selectively engaging the slot and releasing from the slot. These connectors can be used with E-track slots. In one configuration of the rack, the rack assemblies are rotated into one arrangement to retain support structures along an interior wall of the cargo area. In another configuration of the rack, the rack assemblies are swung out of the way when not in use.

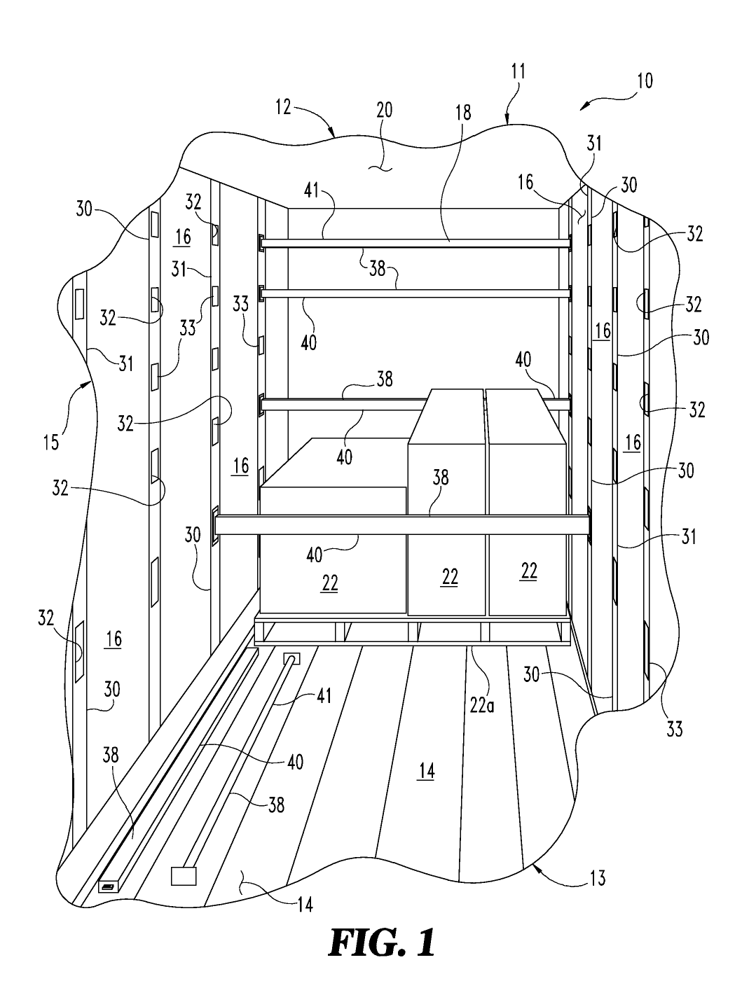

FIG. 1 depicts cargo carrying system 10 of a further embodiment of the present application. System 10 includes vehicle 11 that is of a tractor-trailer type of truck 15 with a portion of trailer 13 specifically depicted. Trailer 13 defines cargo hauling area 12. In other embodiments, vehicle 11 may be a cargo van, a local/regional delivery truck, or such other type of cargo hauling truck as would occur to one skilled in the art. Trailer 13 includes plank interior floor bed 14 opposite ceiling 20, and opposing interior side walls 16. Bed 14, walls 16, and ceiling 20 are joined together by interior head/front wall 18.

Trailer 13 is partially loaded with cargo 22 shown in three separate rectangular solid box packages resting on pallet 22a. Pallet 22a is positioned between cargo 22 and bed 14, and alternatively be provided from decking beams (not shown). Cargo 22 is positioned close to wall 18. Interior walls 16 each include a number of approximately vertical slot tracks 30. Slot tracks 30 each include a number of vertically-aligned, spaced apart elongate slots 32. Tracks 30 are generally flush with interior walls 16 and may be a form of E-track 31 that more specifically define E-track slots 33. E-track 31 is frequently added to cargo hauling areas 12 by attaching a railing that defines raised slots 33. Correspondingly, a channel is formed underneath to seat the bottom of various types of E-track connectors. Typically, such E-track is formed from aluminum, steel, or another durable metal plate, although a different composition may be employed. E-track 31 is often available in vertical and horizontal types, both of which have the longitude of slots 33 oriented vertically. Alternatively, rather than a raised rail, E-track 31 may be embedded in interior walls 16 such that the face of slots 33 are generally flush with walls 16. Such slots 33 may be built-in to walls 16 such that there is no discernable, separate E-track railing—embedded or otherwise.

Whether track 30 is technically of an E-track railing type or not, both types of slots 32 and 33 are generally formed to be compatible with readily available E-track connector types. Often of particular interest are shoring beams, strapping, tie-downs, and other cargo management structures that engage slots 32 in a fixed relationship, but can be selectively released. Many of these structures are configured to extend from one interior side wall 16 to the other interior side wall 16. FIG. 1 depicts various cargo load securement structures 38 that span interior walls 16. More specifically, shoring beams 40 horizontally extend from a connection to slot 32 along one interior side wall 16 to a connection to another slot 32 along the opposing interior side wall 16. As such, these connections to opposing slots 32 tend to place beam 40 under tension along its longitude. Several examples of shoring beams 40 are shown in trailer 13. Often, the specific length of beams 40 has a degree of adjustability. Structures 38 also include load bars 41 that frequently extend between opposing interior side walls 16, but are typically arranged to contact walls 16 with pads or feet under longitudinal compression. Load bars 41 often come equipped with a length-adjustable mechanism such as a ratchet-body to hold nested tubes at a desired, yet alterable length over a certain range.

As previously explained, beams 40 are arranged to secure cargo 22 in place within cargo hauling area 12 of trailer 13. By restricting movement of cargo 22/pallet 22a, safe operation of vehicle 11 can be enhanced. However, it should be observed that one beam 40 and bar 41 are simply resting on bed 14 in the foreground in front of cargo 22/pallet 22a in the lower left corner. As previously indicated, such loose structures 38 can pose a danger in terms of cargo hauling safety and potential property damage, and ordinarily would be secured like the other structures 38 shown in FIG. 1.

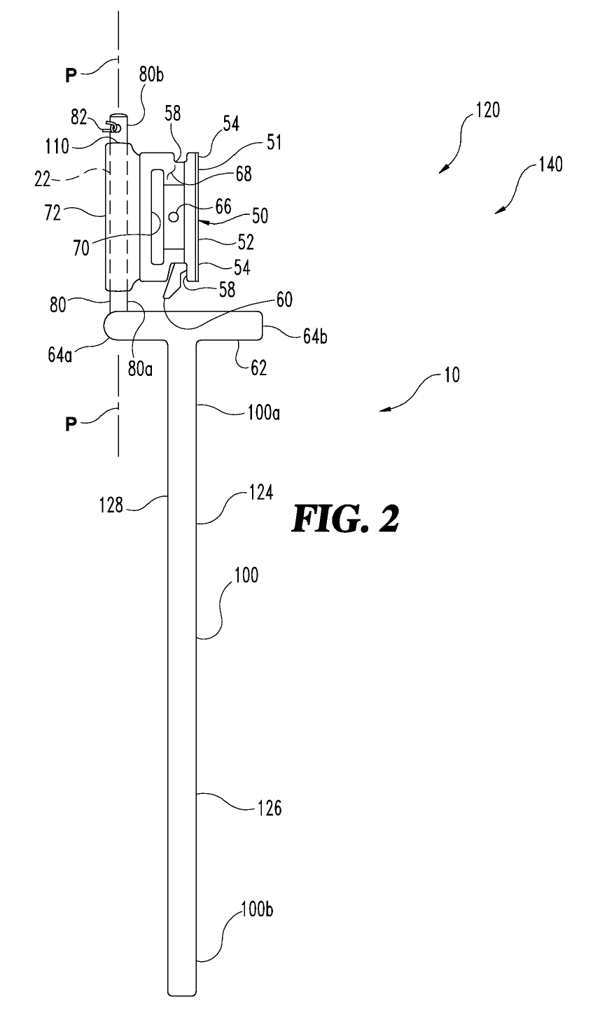

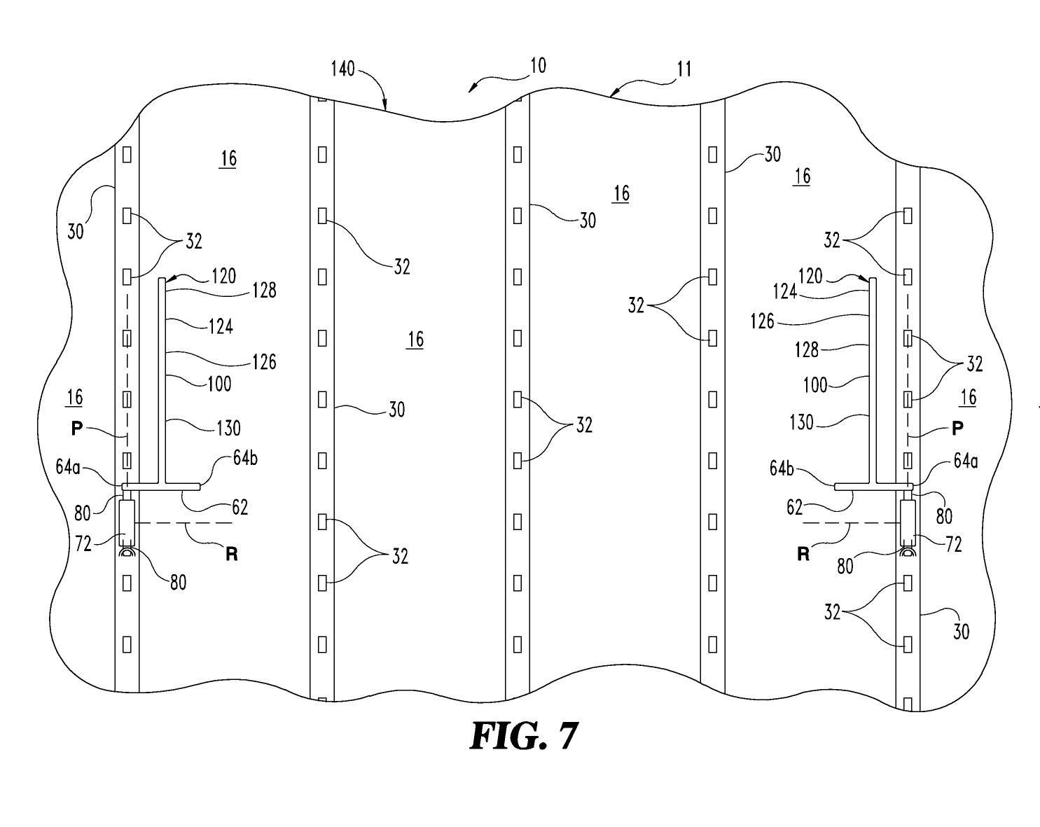

FIG. 2 depicts rack assembly 120 of system 10. Assembly 120 is one of two comprising a cargo load securement structure rack 140. Rack 140 is further described in connection with FIGS. 7-11 hereinafter; however, details of assembly 120 in connection with FIGS. 2-6 are first provided. Referring specifically to FIG. 2, rack assembly 120 includes slot connector 50 compatible with releasable connection to slot 32 or 33 (FIG. 1) in a fixed relationship and is alternatively designated as E-track connector 51. Rack assembly further includes sleeve 72, shaft 80, elongate bar 100, and crossbar 62. Connector 50 is fixed to sleeve 72 that defines passage 122 therethrough. Elongate bar 100 is alternatively designated as mounting bar 124 and guide post 126. Bar 100 is rigidly fixed to crossbar 62 that has inner arm 64a opposite outer arm 64b. Collectively, bar 100 and crossbar 62 provide T-bar 128 with end portion 100a opposite end portion 100b. Shaft 80 includes end portion 80a opposite end portion 80b. End portion 80a is fixed to crossbar 62 so that inner arm 64a is rigidly connected between end portion 100a of bar 100 and end portion 80a of shaft 80. Shaft 80 is received through passage 122 to form a journal bearing 110 therewith. Shaft 80 is secured in passage 122 by a hole/cotter pin mechanism 82 through end portion 80b.

With T-bar 128 rigidly fixed to shaft 80, and connector 50 rigidly connected to sleeve 72; shaft 80 and sleeve 72 rotate or pivot relative to one another about rotational axis P—given journal bearing 110. Rotational axis P extends along the longitude of shaft 80 and passage 122, and is approximately concentric therewith. Accordingly, axis P also serves as a longitudinal centerline axis of shaft 80 and passage 122, and is approximately parallel to the centerline longitude of elongate bar 100. With connector 50 and sleeve 72 held in a relatively fixed position, crossbar 62 (including arms 64a and 64b) and elongate bar 100 (also mounting bar 124 and guide post 126) pivot, rotate, turn, or swing about axis P along with shaft 80.

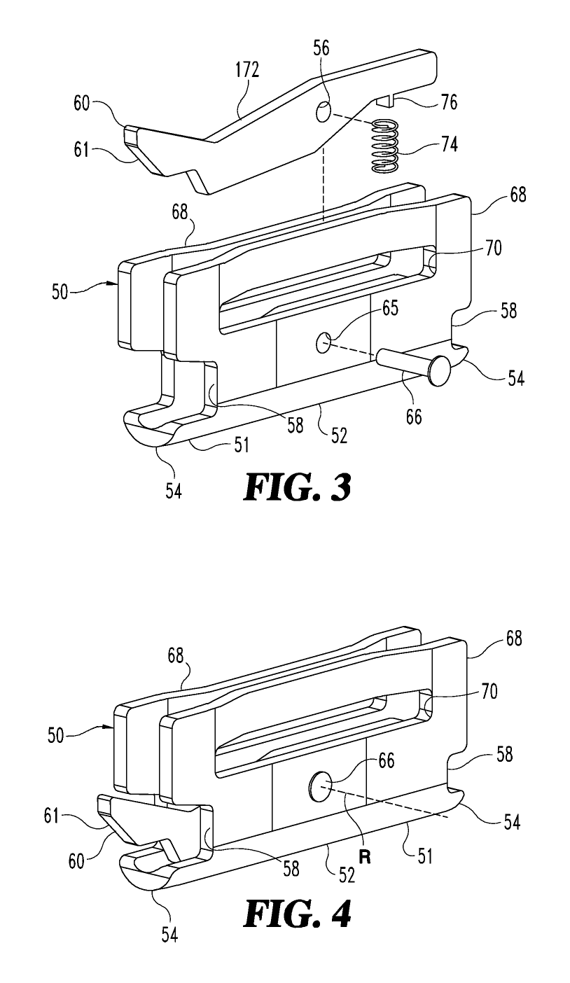

Slot connector 50 includes shoe 52 positioned opposite sleeve 72. Additionally referring to FIGS. 3 and 4, further features of slot connector 50 are depicted in perspective in a partially exploded assembly view and an assembled view, respectively. Connector 50 includes two opposing feet 54 and corresponding opposing notches 58. Each foot 54 and notch 58 is positioned opposite sleeve 72 in addition to each other. Slot connector 50 further includes catch 60 defined with a lever member 61 (FIGS. 3 and 4 only) and helical spring 74 (FIG. 3 only) to provide spring-biasing. Lever member 61 includes lever arm 172 defining pivot pin hole 56 and spring tab 76 (FIG. 3 only). Slot connector 50 includes connector body 68 defined by two opposing plates formed around a mandrel or the like that corresponds to the rounded shape of shoe 52 as best shown by the perspective views of FIGS. 3 and 4. The opposing plates of body 68 define two aligned slits 70 and two aligned pivot pin mounting apertures 65 (only one is visible in FIG. 3). To assemble slot connector 50, spring 74 is captured with tab 76 and lever arm 172 is inserted between the plates comprising body 68—aligning hole 56 with apertures 65 between the plates. Pivot pin 66 is then inserted through one aperture 65, aligned hole 56, and the other aperture 65, and is captured therethrough by swaging or the like. The assembled connector 50 of FIG. 4 results with catch 60 biased by spring 74 downward toward shoe 52. Pivot axis R is approximately concentric with hole 56, apertures 65, and pin 66. By pushing up on spring-biased catch 60 away from shoe 52; catch 60, lever member 61, and arm 172 pivot about axis R against the force of spring 74 held in place by tab 76.

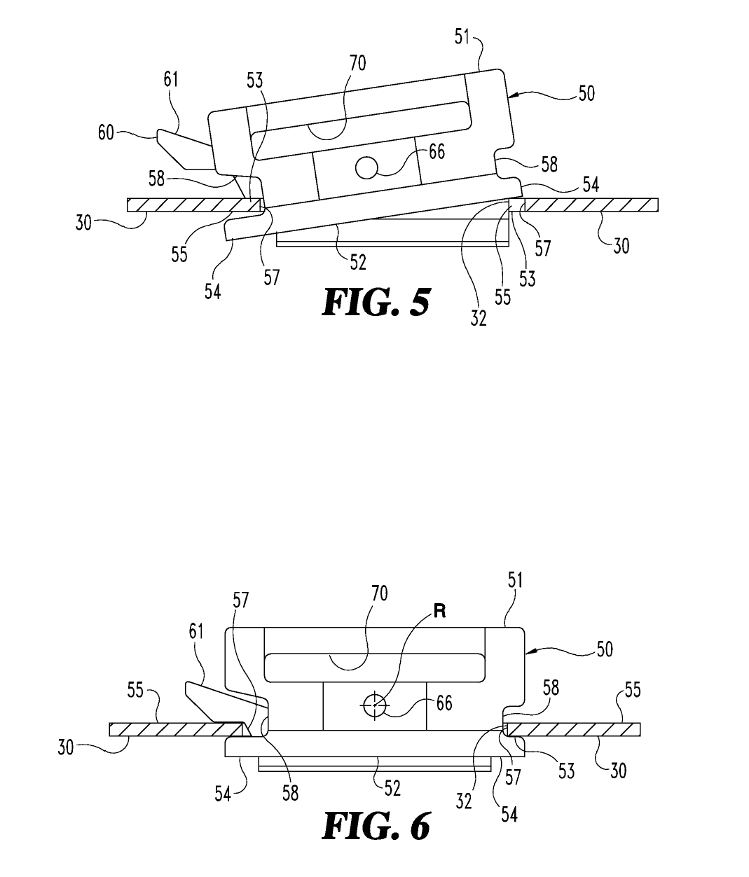

Referring additionally to FIG. 5, catch 60 is in this pushed-up configuration as it is being installed in slot 32 flush with slot track 30. For this partial installation, as catch 60 is held upward, foot 54 on the left is positioned through slot 32 and under the left-side lip 53 and slot margin 55 as edge 57 defined by margin 55 is received in the left-side notch 58. Next, the right side foot 54 is pushed through slot 32 under the right-side lip 53 to receive the right-side edge 57 defined by slot margin 55 in the right-side notch 58 as depicted specifically in FIG. 6. Further, in FIG. 6, catch 60 is released, which under the bias of spring 74 pivots about axis R to move toward shoe 52 to fix slot connector 50 firmly in place. Being generally perpendicular to the view plane of FIG. 6, axis R is represented by like-labeled crosshairs.

Referring back to FIG. 2, slot connector 50 is rigidly fixed to sleeve 72, which pivotally receives shaft 80 rigidly fixed to T-bar 128 to comprise rack assembly 120. Additionally referencing FIG. 7, further detail aspects and features of rack 140 are shown. Rack 140 includes two spaced-apart rack assemblies 120 each having its respective slot connector 50 fixed to a corresponding slot 32 of a different slot track 30. These tracks 30 are approximately parallel to one another and the vertical direction. Rack 140 is illustrated in a stowed configuration 130 with T-bar 128 of each assembly 120 rotated about respective axes P toward wall 16. Typically, stowed configuration 130 positions T-bar 128, and especially outer arm 64b of each assembly 120 to come near to or in contact with wall 16. Assemblies 120 could be secured in stowed configuration 130 by strapping, tie downs, netting, or the like to hold T-bar 128 out of the way (not shown). It should be appreciated that slot connector 50 of each assembly 120 stands-off the corresponding shaft 80 and T-bar 128 by approximately the distance from wall 16 and the face of slot 32 in which connector 50 is mounted and respective rotational axis P. This offset distance plays a role in other configurations to be described hereinafter. It should be appreciated that rotational axes P of each assembly 120 are approximately parallel to each other and tracks 30. Axes P are a coplanar approximation of a vertical plane generally parallel to the view plane of FIG. 7. Pivot axes R (coaxial with pin 66 of connector 50) each cross a respective rotational axis P in an approximately perpendicular relationship without intersecting one another because axis P and axis R are at different distances from wall 16. Further, pivot axes R are approximately collinear and parallel to the FIG. 7 view plane like axes P.

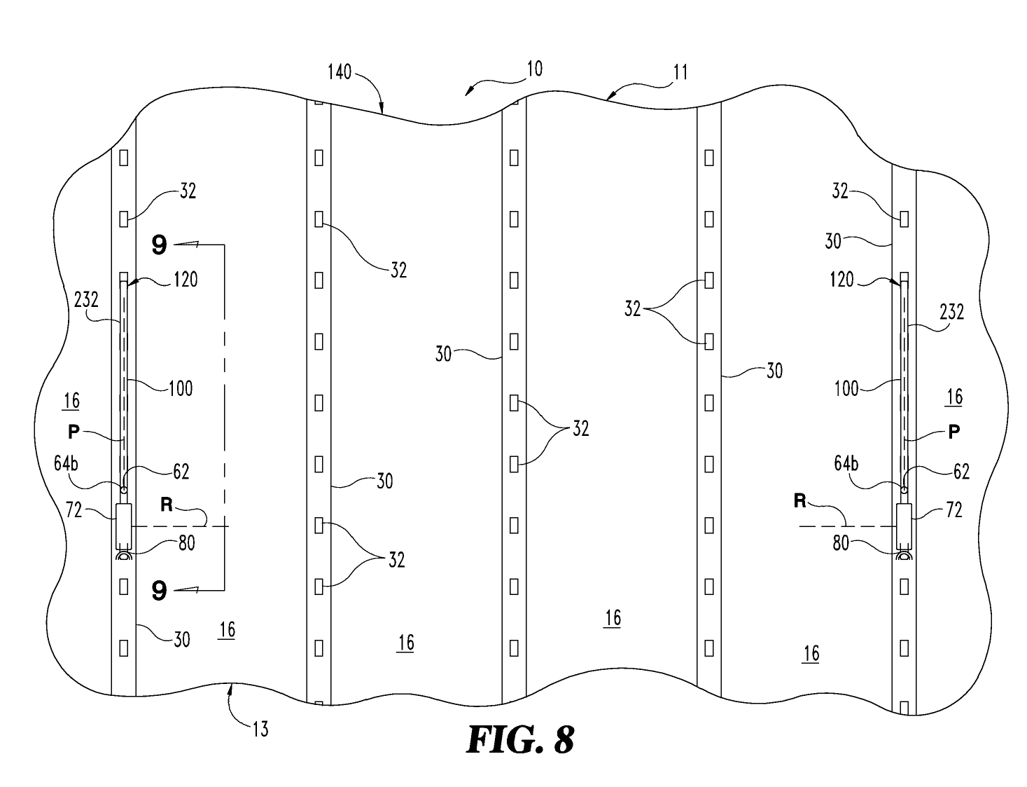

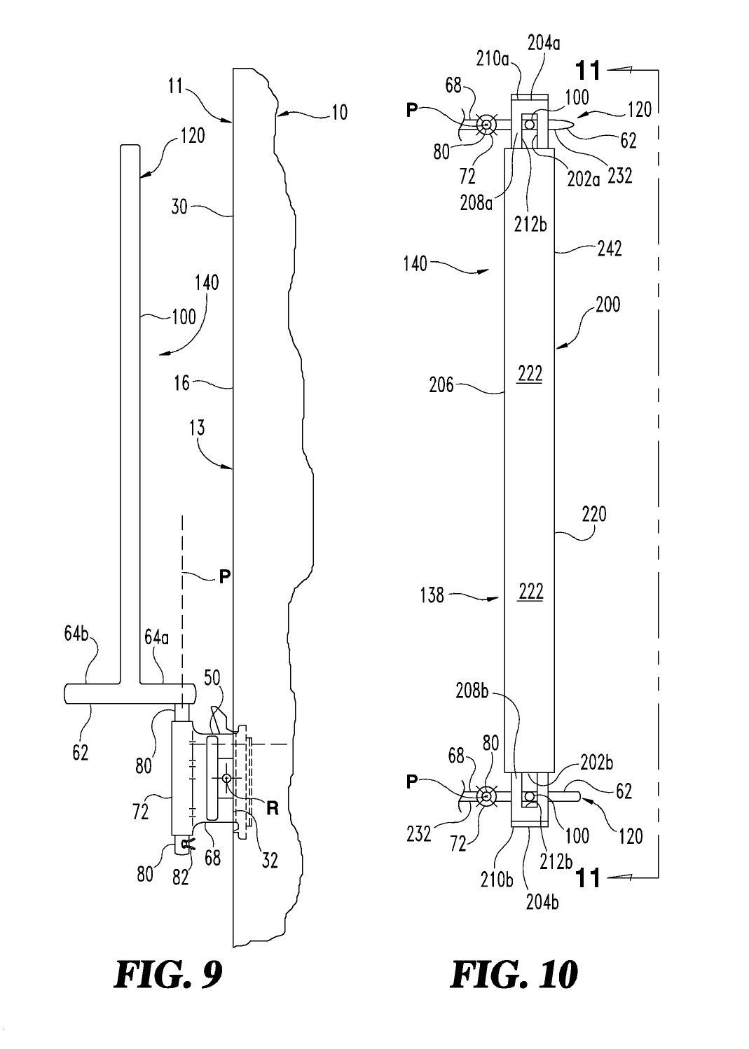

In FIGS. 8 and 9, T-bars 128 are each rotated about the respective axis P to place rack assemblies 120 in configuration 232 to prepare rack 140 for mounting and storage of cargo load securement structures 200. It should be noted that FIG. 9 corresponds to the view line 9-9 shown in FIG. 8 with the corresponding view planes of FIGS. 8 and 9 being perpendicular to one another. In configuration 232, T-bars 128 are each swung to project outer arm 64b of each assembly 120 away from wall 16 along an axis (not shown) that is generally perpendicular to the view plane of FIG. 8 and parallel to the view plane of FIG. 9. Likewise, axis R is represented by crosshairs in FIG. 9, extending generally perpendicular to the FIG. 9 view plane.

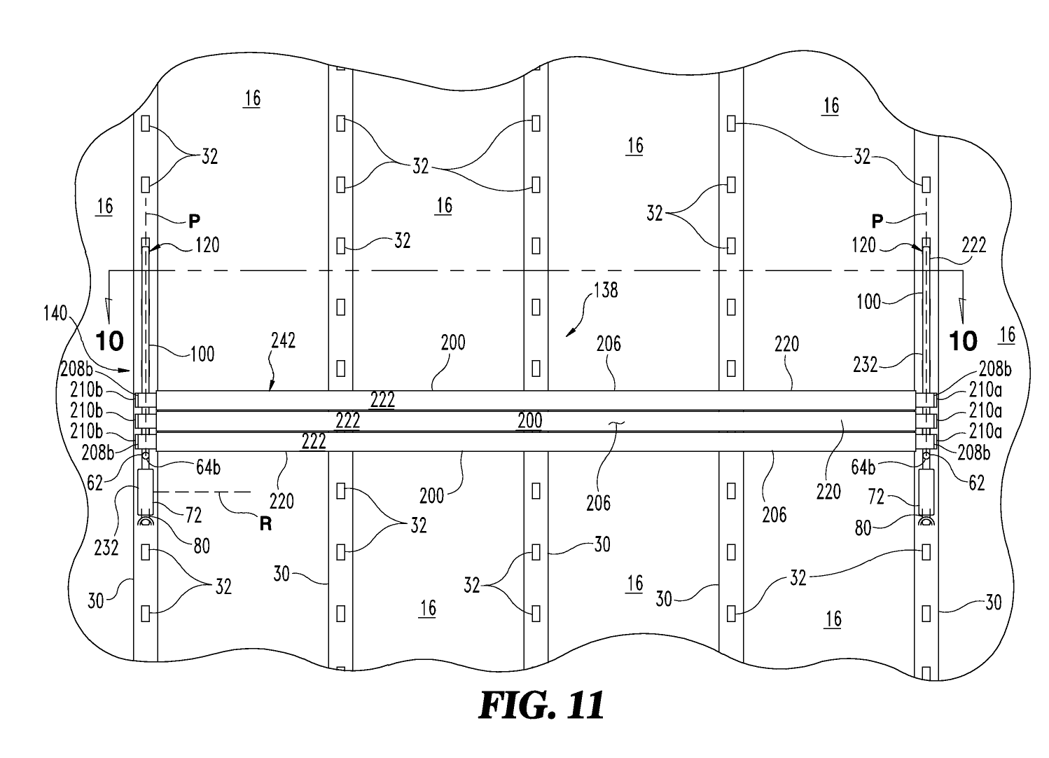

FIGS. 10 and 11 provide different views of structure storage configuration 138 in generally perpendicular view planes with cross-referencing view lines 11-11 (shown in FIGS. 10) and 10-10 (shown in FIG. 11). Axes P are represented by crosshairs in FIG. 10, being generally perpendicular to the view plane. Configuration 138 stores elongate cargo load securement structures 200 (previously defined) in a corresponding structure stack 242. In one form, structures 200 may be a type of adjustable I-beam shoring bar 220, like shoring beams 40, or the like that may be used to secure/support cargo as desired within trailer 13—typically horizontally spanning the distance between opposing interior walls 16 with mounting to respective opposing slots 32. Each elongate structure 200 is covered by sleeve 222 and includes opposing end portions 210a and 210b. End portions 210a and 210b include projecting beams/bars 208a and 208b, respectively that are each terminated by a corresponding slot connector 204a and 204b. The amount of projection of bars 208a and 208b from sleeve 222 typically can be varied over a set range by sliding engagement or may be of fixed length in the alternative. Collectively, bar 208a terminates with slot connector 204a to define protruding passage 202a (alternatively designated as mounting hole 212a); and bar 208b terminates with slot connector 204b to define a protruding passage 202b (alternatively designated as mounting hole 212b).

Correspondingly, there are opposing end portion 210a, 210b passages 202a, 202b that are aligned with end portions 100b of elongate bars 100, (alternatively, mounting bars 124 or guide posts 126) of each assembly 120 in configuration 232. So aligned, structures 200 are lowered with elongate bars 100 extending through respective passages 202a, 202b (alternatively, mounting holes 212a, 212b) until the mounted structure 206 rests on crossbars 62 for each assembly 120. Repeating this procedure, additional structures 200 can be mounted on bars 100 to come to rest on the previously mounted structure 206. Altogether, mounted structures 206 form a structure stack 242 as perhaps best shown in FIG. 11. Three stacked structures 206 are depicted in FIG. 11, but in other embodiments, more or fewer structures 206 may be stored in this manner. In one particular embodiment, a stack 242 of five mounted structures 206 provides a desirable maximum. Once stack 242 is formed, it can be further secured by strapping, chains, slot connector tie-downs, or the like. In this way, unused structures 200 can be stored in a safe and efficient manner with rack 140 in configuration 138. To reuse mounted structures 206, the mounting procedure is reversed by lifting each structure 200 to dismount from assemblies 120 until empty. Once empty, T-bars 128 can be swung towards wall 16 for stowing in configuration 130 while not in use, and optionally applying any securing straps, tie-downs, or the like. Alternatively, either assembly 120 or both may be disconnected from wall 16 and otherwise stored away until remounted for structure 200 storage again.

Any theory, thesis, hypothesis, operation mechanism, proof, example, speculation, or finding stated herein is meant to further enhance understanding of one or more of the claimed inventions and is not intended to make any claimed invention in any way dependent upon or limited to such theory, thesis, hypothesis, operation mechanism, proof, example, speculation, and/or finding. Furthermore, reference throughout the present application to “embodiment” (with or without modifier) means that particular aspects described in connection with such embodiment are included in at least one embodiment and may also be included in one or more other embodiments. Multiple references to “embodiment” herein (with or without modifier) are not necessarily all referring to the same embodiment. For avoidance of doubt, all claim language shall be interpreted to be of the “open” type unless expressly limited by a: (a) “closed” transition (consists of, consist of, or consisting of), (b) “partially closed” transition (consisting essentially of, consist essentially of, or consists essentially of), (c) negative modifier (alone, exclusive(ly), just, no, not, none, only, solely, or without), (d) negation by suffix (-less), (e) negation by prefix (de-, dis-, it-, in-, im-, it-, mis-, non-, or un-), (f) limitation by conjunction (but or whereby) and the like. It should be understood that any use of the words “important, critical, crucial, significant, essential, salient, imperative, substantial, extraordinary, favor, favored, favorably, favorable, desire, desired, desirable, desirably, prefer, preferable, preferably, preference, and preferred” as modifiers in the description above indicates that the feature so described may be desirable, and further may be used to indicate different degrees of desirability among different features; however, any such feature(s) is nonetheless not to be incorporated or otherwise required in any of the claims set forth hereinafter unless expressly described therein and further such features do not preclude the existence of embodiments of the present invention/application lacking the same. In any method or process claim that follows, it should be recognized that the features must be written in some order/sequence and so no presumption of such order/sequence is thereby intended (temporal or otherwise), and further some or all of such features may be performed concurrently, in a different order/sequence than listed, or in varying order/sequence (notwithstanding indefinite or definite article usage with such features)--except to the extent: one feature requires another feature before or after for a valid, operational, and otherwise proper claim construction or an express order/sequence is recited in the claim. There is no intent that a given feature of a claim be interpreted as a means or step for performing a specified function unless expressly accompanied by recitation of the language “means for” or “step for” respectively. Representative embodiments have been provided in detail in the foregoing description potentially under various headings/subheadings; however, such headings/subheadings (to the extent present) are for convenience only and do not interpret, define, limit, or otherwise indicate the scope or meaning of any embodiments or inventions set forth herein, including any claims that follow. While representative embodiments have been illustrated and described in detail herein, the same is illustrative only and not restrictive in character, it being understood that only representative embodiments have been described, and that all additions, advantages, alterations, apparatus, applications, aspects, benefits, changes, components, compositions, constituents, devices, embodiments (described or undescribed), equivalents, features, forms, implementations, materials, methods, modifications, objects, operations, options, processes, refinements, structures, substitutions, subtractions, systems, techniques, and variations that come within the spirit, scope, and/or meaning of any inventions defined herein, including any of the following claims, are desired to be protected.

1-12. (canceled)

13. A method, comprising:
connecting a first rack assembly along an interior wall of a cargo area of a vehicle with a first connector, the first rack assembly including a guide bar fixed to a crossbar, the crossbar being coupled to the first connector;
positioning the first rack assembly to project an arm of the crossbar away from the interior wall and direct the guide bar upwardly from the crossbar;
selecting a first cargo securement support defining a passage therethrough; and
placing the guide bar through the passage to rest the first cargo securement support on the crossbar.

14. The method of claim 13, which includes:
equipping the cargo area with a second rack assembly including a further guide bar fixed to a further crossbar and a second connector coupled to one end of the further crossbar;
coupling the first connector to a first slot and the second connector to a second slot along the interior wall, the first slot belonging to a first slot track and the second slot belonging to a second slot track, the first slot track and the second slot track being approximately parallel to one another;
configuring the second rack assembly to project the further crossbar from the interior wall and upwardly direct the further guide bar therefrom; and
putting the further guide bar through a further passage defined by the first cargo securement support at an end opposite the passage to rest the first cargo securement support on the further crossbar.

15. The method of claim 14, which includes:
removing the cargo securement support from the first rack assembly and the second rack assembly;
pivoting the guide bar and crossbar and the further guide bar and the further crossbar to be closer to the interior wall.

16. The method of claim 14, which includes:
selecting a second cargo securement support defining a first protruding slot opposite a second protruding slot;
projecting the guide bar through the first protruding slot and the further guide bar through the second protruding slot to stack the second cargo securement support on the first cargo securement support;
selecting a third cargo securement support defining a first protruding aperture opposite a second protruding aperture; and
placing the guide bar through the first protruding aperture and the further guide bar through the second protruding aperture to stack the third cargo securement support on the second cargo securement support.

17. The method of claim 13, in which the positioning of the first rack assembly includes pivoting the guide bar and the crossbar relative to the first connector and the interior wall while the first connector engages a first slot defined along the interior wall.

18. The method of claim 17, which includes:
equipping the first rack assembly with a shaft and a sleeve;
receiving the shaft in the sleeve, the sleeve being fixed to the first connector;
rotating the shaft in the sleeve during the pivoting of the guide bar and the crossbar, a corresponding rotational axis longitudinally extending through the shaft and the sleeve;

19. The method of claim 18, which includes:
implementing the first connector with a pivotal catch having a pivot axis generally perpendicular to the rotational axis;
activating the catch to at least one of engage the first connector to the first slot and release the first connector from the first slot;
providing a second rack assembly with a further guide bar fixed to a further crossbar, the further crossbar including a first arm opposite a second arm, the first arm being fixed to a shaft opposite the further guide bar, the second arm projecting away from the interior wall with the guide bar extending upwardly therefrom;
including the second rack assembly with a further sleeve receiving the further shaft therein and a second connector fixed to the sleeve;
equipping the second connector with a first foot opposite a second foot, the first foot and the second foot being positioned under opposing edges of a second slot when engaged thereto; and
putting the further guide bar through a further passage defined by the cargo securement support to rest on the further crossbar.

20. The method of claim 19, which includes:
supplying the first slot with a first edge opposing a second edge;
providing the first connector with a first notch opposing a second notch; and
receiving the first edge in the first notch and the second edge in the second notch to engage the first connector to the first slot;
the first notch and the second notch being positioned opposite the sleeve, and the first foot and the second foot being positioned opposite the further sleeve;
lifting the first cargo securement support from the first rack assembly to remove the guide bar from inside the passage and the second rack assembly to remove the further guide bar from inside the further passage; and
swinging the first rack assembly and the second rack assembly to move the guide bar, the crossbar, the further guide bar, and the further crossbar closer to the interior wall after the lifting of the first cargo securement support.
